(19) United States
(12) Patent Application Publication
(10) Pub. No.: US 2004/0258160 A1
(43) Pub. Date: Dec. 23, 2004

(54) System, method, and apparatus for decoupling video decoder and display engine

(76) Inventor: Sandeep Bhatia, Bangalore (IN)

Correspondence Address: Christopher C. Winslade, McAndrews, Held & Malloy, LTD., 34th Floor, 500 West Madison Street, Chicago, IL, 60661, US

(21) Appl. No.: 10/600,245

(22) Filed: Jun. 20, 2003

(51) Int. Cl. H04N 7/12

(52) U.S. Cl. 375/240.25; 375/240.01; 375/240.12

(57) ABSTRACT

Presented herein are a system, method, and apparatus for decoupling the video decoder and display engine. Parameter buffers and a queue indicate display parameters and display order for the display engine to appropriately present the frame for display.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The process of presenting an MPEG encoded video includes a decoding process and a displaying process. The decoding process decodes the MPEG encoded video. The decoded MPEG video comprises individual frames from the video. The displaying process includes rendering and scaling the frames for display on a display device, such as a monitor or television screen.

The MPEG encoded frames include a number of control parameters for decoding and presenting the frames forming the video. These parameters are parsed by the decoding process. In conventional systems, the decoding process and the displaying process are tightly coupled. As a result of the tight coupling, the display engine has access to the parameters needed to display the frames.

Additionally, as a result of tight coupling between the decoding process and the displaying process, the display process selects a decoded frame for display. Encoding video data in accordance with an MPEG standard, such as MPEG-2 or AVC includes compression techniques that take advantage of temporal redundancies. A frame, known as a predicted frame, can be represented as a set of offsets and spatial displacements with respect to another frame, known as a reference frame. Additionally, the predicted frame can also be described as a set of offsets and spatial displacements from various portions of two or more frames. Furthermore, the reference frame can itself be predicted from another reference frame.

The prediction frame and the reference frame(s) can have a variety of temporal relationships with respect to one another. For example, MPEG-2 defines three types of frames, known as I-frames, P-frames, and B-frames. An I-frame is not predicted from any other frame. A P-frame is predicted from an earlier frame. A B-frame is predicted from portions of an earlier frame and portions of a later frame. Both the I-frame and P-frames serve as reference frames for other frames.

The existence of B-frames causes differences in the decoding and display ordering. Predicted frames are data dependent on the reference frames. As a result, the reference frames are decoded prior to the predicted frames. However, in the case of B-frames, one of the reference frames is displayed after the B-frame.

After the decoding process decodes a frame, the frame is stored in a frame buffer. With B-frames, frame buffers store a past prediction frame and a future prediction frame, and a third frame buffer is used to build the B-frame. As a result of tight-coupling of the decode process and the display process, the display process selects the frames from the frame buffer in the frame display order for display.

However, the tight-coupling between the decoding process and the display process has disadvantages. The decoding process and the display process are usually run on the same processor and have to be carefully synchronized with respect to one another. The foregoing results in significant design constraints.

Further limitations and disadvantages of conventional and traditional approaches will become apparent to one of skill in the art through comparison of such systems with embodiments presented in the remainder of the present application with reference to the drawings.

### BRIEF SUMMARY OF THE INVENTION

Presented herein are a system, method, and apparatus for presenting images for display. In one embodiment, there is presented a system comprising a decoder, image buffers, a queue, and a display engine. The decoder decodes encoded images and parameters associated with the images, thereby resulting in decoded images and decoder parameters associated with the decoded images. The image buffers store the decoded images. The queue stores indicators indicating images to be displayed in the display order. The display engine presents the images indicated by the queue for display.

In another embodiment, there is presented a method for displaying images on a display. The method includes decoding encoded images and parameters associated with the images, thereby resulting in decoded images and decoder parameters associated with the decoded images, storing the decoded images, queueing indicators indicating images to be displayed, and presenting the images indicated by a particular one of the indicators for display.

In another embodiment, there is presented a circuit for displaying images on a display. The circuit includes a processor and a memory. The memory stores a plurality of executable instructions. The plurality of executable instructions cause decoding encoded images and parameters associated with the images, thereby resulting in decoded images and decoder parameters associated with the decoded images, storing the decoded images, queuing indicators indicating images to be displayed, and presenting the images indicated by the queued indicators for display.

In another embodiment, there is presented a circuit for displaying images on a display. The circuit includes a first processor, a first memory, a second processor, and second memory. The first memory stores a plurality of instructions for execution by the first processor. The plurality of executable instructions cause decoding encoded images and parameters associated with the images, thereby resulting in decoded images and decoder parameters associated with the decoded images, storing the decoded images, and storing indicators indicating images to be displayed in a queue. The second memory stores a plurality of instructions for execution by the second processor. The plurality of executable instructions for execution by the second processor cause presenting the images indicated by the indicators for display.

In another embodiment, there is presented a system for displaying images on a display. The system includes a decoder, image buffers, and a display engine. The decoder is for decoding encoded images and parameters associated with the images, thereby resulting in decoded images and decoder parameters associated with the decoded images, wherein the decoder comprises a first processor. The image buffers are for storing the decoded images. The display engine is for presenting the images stored in the image buffers for display, wherein the display engine comprises a second processor.

These and other novel advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram describing an exemplary decoder system in accordance with an embodiment of the present invention;

FIG. 2 is a flow diagram for presenting images in accordance with an embodiment of the present invention;

FIG. 3A is a block diagram describing encoding of a video in accordance with the MPEG-2 standard;

FIG. 3B is a block diagram of exemplary pictures;

FIG. 3C is a block diagram of pictures in decode order;

FIG. 3D is a block diagram of MPEG-2 hierarchy; and

FIG. 4 is a block diagram of an exemplary MPEG-2 decoder system in accordance with an embodiment of the present invention.

### DETAILED DESCRIPTION OF THE INVENTION

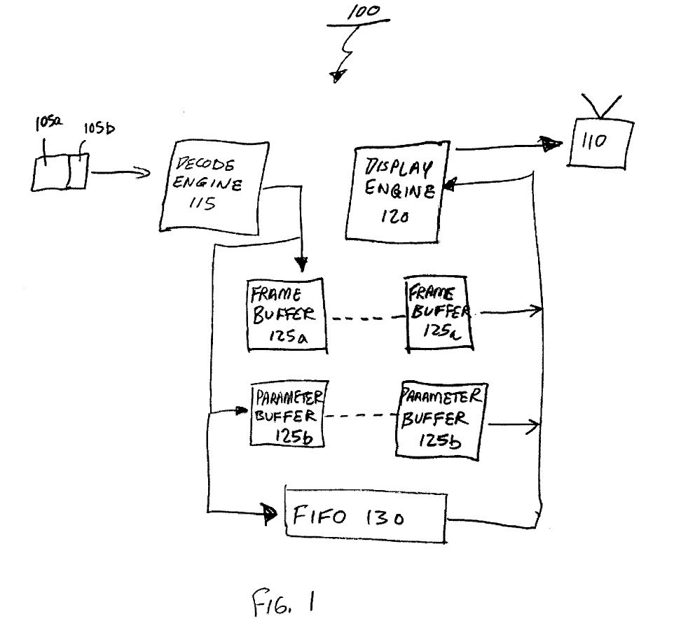

Referring now to FIG. 1, there is illustrated a block diagram of an exemplary decoder 100 for displaying images. The decoder 100 receives encoded data 105 that includes encoded images 105a and associated parameters 105b and displays the images on the display device 110. An encoder encodes the images according to a predetermined standard. The predetermined standard can include, for example, but is not limited to, MPEG-2 or AVC. The encoder also encodes a number of parameters 105b for each image that facilitate the decoding and displaying process. These parameters 105b can include, for example, the decode time, presentation time, horizontal size, vertical size, or the frame rate. The encoder makes a number of choices for encoding the images and parameters in a manner that satisfies the quality requirements and channel characteristics. However, the decoder 100 has limited choices while decoding and displaying the images. The decoder 100 uses the decisions made by the encoder to decode and display frames with the correct frame rate at the correct times, and the correct spatial resolution.

The decoder can be partitioned into two sections—a decode engine 115 and a display engine 120. The decode engine 115 decodes the encoded images 105a and parameters 105b and generates decoded images. Decoding by the decode engine 115 can also include decompressing compressed images, wherein the images are compressed. The decoded images include raw pixel data. The display engine 120 renders graphics and scales the images for display. After an image is decoded, the decode engine 115 stores the decoded image in one of several frame buffers 125a. The display engine 120 retrieves the image from the frame buffer 125a for display on the display device.

The decode engine 115 and the display engine 120 can be implemented as functions on either a common processor or separate processors. The decode engine 115 and the display 120 can be independent functions or tightly-coupled.

The decode engine 115 also decodes control parameters 105b associated with each image 105a. In order for the display engine 120 to accomplish its objective of being able to present the decoded images at their correct intended presentation time, the display engine 120 uses various parameters 105b decoded by the decode engine. However, to allow for flexibility in the implementation of the decode engine 115 and the display engine 120, the parameters 105b associated with an image 105a that are used by the display engine 120 are stored in a parameter buffer 125b associated with the frame buffer 125a storing the image.

Additionally, encoding video in accordance with certain standards, such as MPEG-2 or AVC includes compression techniques that take advantage of temporal redundancies. An image, known as a predicted image, can be represented as a set of offsets and spatial displacements with respect to another image, known as a reference image. Additionally, the predicted image can also be described as a set of offsets and spatial displacements from various portions of two or more images. Furthermore, the reference image can itself be predicted from another reference image.

The predicted image and the reference image(s) can have a variety of temporal relationships with respect to one another. For example, a predicted image can be predicted from portions of an earlier image and portions of a later image.

Predicted images are data dependent on the reference images. As a result, the reference images are decoded prior to the predicted images. However, in the case where images are predicted from a future reference image, the future reference image is decoded before decoding the predicted image, but displayed after the predicted image. As noted above, after each image is decoded, the decoder engine 115 stores the decoded image in one of the frame buffers 125a.

In order for the display engine 120 to select the correct images from the frame buffers 125a, the decoder 115 parses the parameters 105b associated with each image 105a and generates a FIFO queue 130. The FIFO queue 130 is a queue that indicates the display order of the images, wherein each element in the FIFO queue 130 indicates the frame buffer 125a storing the next image to be displayed.

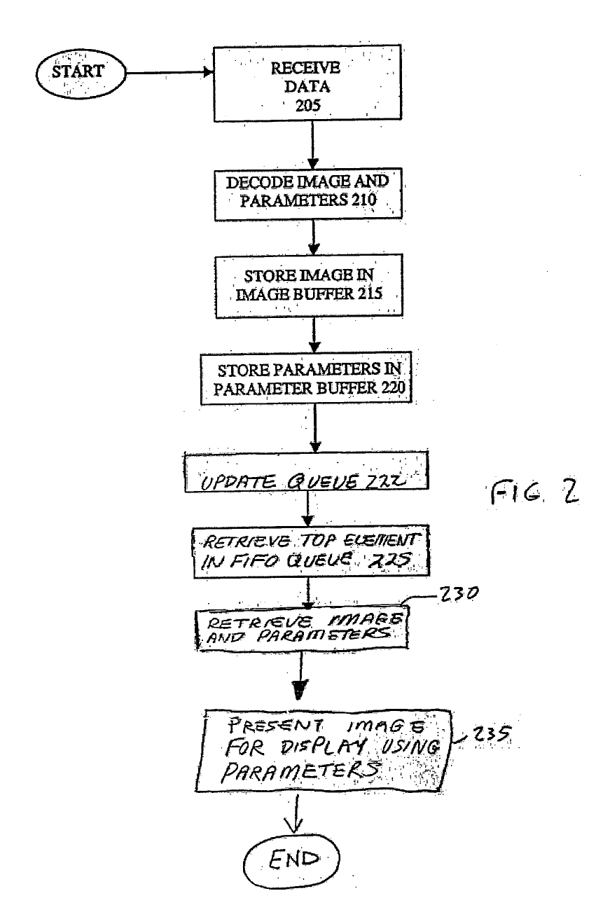

Referring now to FIG. 2, there is illustrated a flow diagram describing the decoding and displaying of an image in accordance with an embodiment of the present invention. At 205, data comprising encoded images and encoded parameters is received by the decode engine 115. At 210, the decode engine 115 decodes the image and parameters. The decoded image is buffered in an image buffer 125a (at 215) and the parameters are stored in the parameter buffer 125b (at 220) associated with the image buffer 125a. The decode engine 120 determines the image from the images in the image buffers 125a that is to be displayed at the nearest time in the future. At 222, the decode engine 120 places an indicator at the end of the FIFO queue 130 indicating the image to be displayed at the nearest time in the future.

At 225, the display engine 120 retrieves the top element in the FIFO queue 130. The top element in the FIFO queue 130 indicates the next image to be displayed. At 230, the display engine 120 retrieves the image indicated by the top element in the FIFO queue 130 and the parameters stored in the parameter buffer 125b associated with the frame buffer 125a. At 235, the display engine 120 presents the image for display using the parameters stored in the parameter buffer 125b.

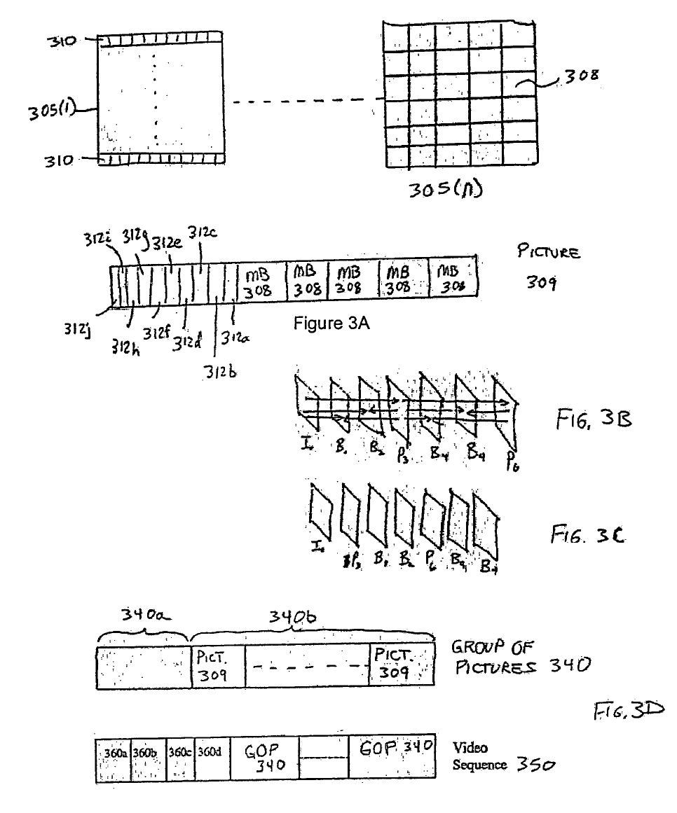

Referring now to FIG. 3A, there is illustrated a block diagram of a video encoded in accordance with the MPEG-2 standard. The video comprises a series of frames 305. The frames 30 comprise any number of lines 310 of pixels, wherein each pixels stores a color value.

Pursuant to MPEG-2, the frames 305(1) . . . 305(n) are encoded using algorithms taking advantage of both spatial redundancy and/or temporal redundancy. Temporal encoding takes advantage of redundancies between successive frames. A frame can be represented by an offset or a difference frame and/or a displacement with respect to another frame. The encoded frames are known as pictures. Pursuant to MPEG-2, each frame 305(1) . . . 305(n) is divided into 16×16 pixel sections, wherein each pixel section is represented by a macroblock 308. A picture 309 comprises macroblocks 308 representing the 16×16 pixel sections forming the frame 305.

Additionally, the pictures 309 include additional parameters 312. The parameters can include, for example, a still picture interpolation mode 312a, a motion picture interpolation mode 312b, a presentation time stamp (PTS) present flag 312c, a progressive frame flag 350d, a picture structure indicator 312e, a PTS 312f, pan-scan vectors 312g, aspect ratio 312h, decode and display horizontal size parameter 312i, and a decode and display vertical size parameter 312j. It is noted that in the MPEG-2 standard, additional parameters may be included. However, for purpose of clarity, some parameters are not illustrated in FIG. 3.

Referring now to FIG. 3B, there is illustrated an exemplary block diagram of pictures I0, B1, B2, P3, B4, B5, and P6. The data dependence of the pictures is illustrated by the arrows. For example, picture B2 is dependent on reference pictures I0 and P3. Pictures coded using temporal redundancy with respect to either exclusively earlier or later pictures of the video sequence are known as predicted pictures (or P-pictures), for example picture P3. Pictures coded using temporal redundancy with respected to earlier and later pictures of the video are known as bi-directional pictures (or B-pictures), for example, pictures B1, B2. Pictures not coded using temporal redundancy are known as I-pictures, for example I0. In MPEG-2, I an P-pictures are reference pictures.

The foregoing data dependency among the pictures 309 requires decoding of certain pictures prior to others. Additionally, the use of later pictures 309 as reference pictures for previous pictures, requires that the later picture is decoded prior to the previous picture. As a result, the pictures 309 cannot be decoded in temporal order. Accordingly, the pictures 309 are transmitted in data dependent order. Referring now to FIG. 3C, there is illustrated a block diagram of the pictures in data dependent order.

The pictures are further divided into groups known as groups of pictures (GOP). Referring now to FIG. 3D, there is illustrated a block diagram of the MPEG hierarchy. The pictures of a GOP are encoded together in a data structure comprising a picture parameter set 340a and a GOP payload 340b. The GOP payload 340b stores each of the pictures in the GOP in data dependent order. GOPs are further grouped together to form a video sequence 350. The video data is represented by the video sequence 350.

The video sequence 350 includes sequence parameters 360. The sequence parameters can include, for example, a progressive sequence parameter 360a, a top field first parameter 360b, a repeat first field parameter 360c, and a frame parameter 360d.

It is noted that in the MPEG-2 standard, additional parameters may be included. However, for purposes of clarity, some parameters are not illustrated in FIGS. 3A-3D.

The progressive sequence parameter 360a is a one-bit parameter that indicates whether the video sequence 350 has only progressive pictures. If the video sequence 350 has only progressive pictures, the progressive sequence parameter 360a is set. Otherwise, the progressive sequence parameter 360a is cleared.

The top field first parameter 360b is a one-bit parameter that indicates for an interlaced sequence whether the top field should be displayed first or the bottom field should be displayed first. When set, the top field is displayed first, while when cleared, the bottom field is displayed first.

The repeat first field 360c is a one-bit parameter that specifies whether the first displayed field of the picture is to be redisplayed after the second field. For a progressive sequence, the repeat first field 360c forms a two-bit binary along with the top field first parameter 360b specifying the number of times that a progressive frame should be displayed. The frame rate 360d indicates the frame rate of the video sequence.

The video sequence 360 is then packetized into a packetized elementary stream and converted to a transport stream that is provided to a decoder.

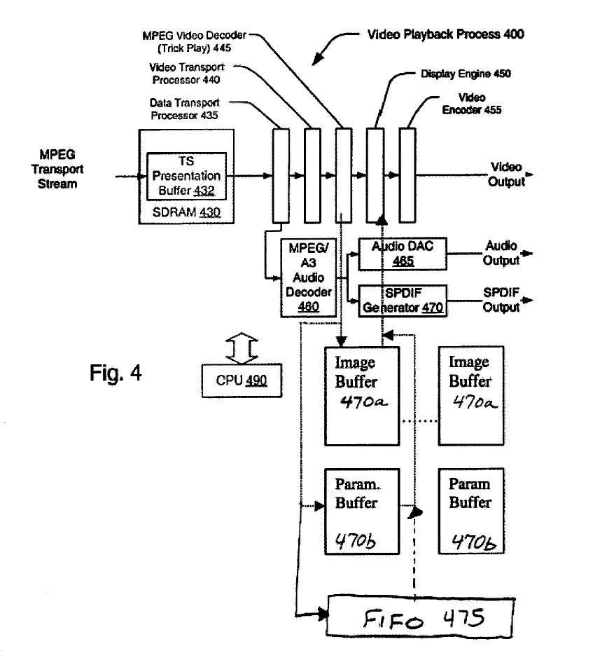

Referring now to FIG. 4, there is illustrated a block diagram of a decoder configured in accordance with certain aspects of the present invention. A processor, that may include a CPU 490, reads an MPEG transport stream into a transport stream buffer 432 within an SDRAM 430. The data is output from the transport stream presentation buffer 432 and is then passed to a data transport processor 435. The data transport processor 435 then passes the transport stream to an audio decoder 460 and the video video transport processor 440. The video transport processor 440 converts the video transport stream into a video elementary stream and sends the video elementary stream to a video decoder 445. The video elementary stream includes encoded compressed frames and parameters. The video decoder 445 decodes the video elementary stream. The video decoder 445 decodes the encoded compressed frames and parameters in the video elementary stream, thereby generating decoded frames containing raw pixel data. After a frame is decoded, the video decoder 445 stores the frame in a frame buffer 470a.

The display engine 450 is responsible for and operable to scale the video picture, render the graphics, and construct the complete display among other functions. Once a frame is ready to be presented, the frame is passed to the video encoder 455 where it is converted to analog video using an internal digital to analog converter (DAC). The digital video is converted to analog in the audio digital to analog converter (DAC) 465. The display engine 450 prepares the frames for display on a display device.

The video decoder 445 and the display engine 450 can be implemented as functions on either a common processor or separate processors. The video decoder 445 and the display engine 450 can be independent functions or tightly-coupled.

The video decoder 445 also decodes control parameters associated with each frame. The control parameters can include, for example, the decode time, presentation time, horizontal size, vertical size, or the frame rate. The parameters are used both during the decoding process by the video decoder 445 and the display process by the display engine 450.

In order for the display engine 450 to accomplish its objective of being able to present the decoded frames at their correct intended presentation time, the display engine 450 uses various parameters decoded by the decode engine. However, to allow for flexibility in the implementation of the video decoder 445 and the display engine 450, the parameters associated with a frame that are used by the display engine 450 are stored in a parameter buffer 470b associated with the frame buffer 470a storing the frame.

As noted above, the existence of B-frames causes differences in the decoding and display ordering. Predicted frames are data dependent on the reference frames. As a result, the reference frames are decoded prior to the predicted frames. However, in the case of B-frames, one of the reference frames is displayed after the B-frame. After the decoding process decodes a frame, the frame is stored in a frame buffer 470a.

In order for the display engine 450 to select the correct frame from the frame buffers 470a, the decoder 445 parses the parameters associated with each frame and generates a FIFO queue 475. The FIFO queue 475 is a queue that indicates the display order of the frames, wherein each element in the FIFO queue 130 indicates the frame buffer 470a storing the next frame to be displayed. The display engine 455 examines the indicators in the FIFO queue 475 to determine the next frame for display.

The decoder system as described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. Alternatively, if the processor is available as an ASIC core or logic block, then the commercially available processor can be implemented as part of an ASIC device wherein certain operations are implemented as instructions in firmware.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A system for displaying images on a display, said system comprising:
a decoder for decoding encoded images and parameters associated with the images, thereby resulting in decoded images and decoder parameters associated with the decoded images;
image buffers for storing the decoded images;
a queue for storing indicators indicating images to be displayed; and
a display engine for presenting the images indicated by the queue for display.

2. The system of claim 1, further comprising:
parameter buffers for storing the decoded parameters associated with the images.

3. The system of claim 2, wherein the display engine presents the images indicated by the queue for display by receiving the decoded parameters and displaying the decoded images based on the decoded parameters.

4. The system of claim 1, wherein the decoder comprises a first processor and the display engine comprises a second processor.

5. A method for displaying images on a display, said method comprising:
decoding encoded images and parameters associated with the images, thereby resulting in decoded images and decoded parameters associated with the decoded images;
storing the decoded images;
queuing indicators indicating images to be displayed; and
presenting the images indicated by a particular one of the indicators for display.

6. The method of claim 5, further comprising:
storing the decoded parameters associated with the images.

7. The method of claim 6, wherein presenting the images for display further comprises receiving the decoded parameters and displaying the decoded images based on the decoded parameters.

8. A circuit for displaying images on a display, said circuit comprising:
a processor;
a memory operably coupled to the processor, said memory storing a plurality of executable instructions, wherein the plurality of executable instructions cause:
decoding encoded images and parameters associated with the images, thereby resulting in decoded images and decoder parameters associated with the decoded images;
storing the decoded images;
queuing indicators indicating images to be displayed; and
presenting the images indicated by the queued indicators for display.

9. The circuit of claim 8, further comprising:
storing the decoded parameters associated with the images.

10. The circuit of claim 9, wherein the instructions causing presenting the images further comprise instructions causing receiving the decoded parameters and displaying the decoded images based on the decoded parameters.

11. A circuit for displaying images on a display, said circuit comprising:
a first processor;
a first memory operably coupled to the first processor, said first memory storing a plurality of instructions for execution by the first processor, wherein the plurality of executable instructions cause:
decoding encoded images and parameters associated with the images, thereby resulting in decoded images and decoder parameters associated with the decoded images;
storing the decoded images;
storing indicators indicating images to be displayed in a queue; and
a second processor operably coupled to the queue;
a second memory operably coupled to the second processor, said second memory storing a plurality of instructions for execution by the second processor, wherein the plurality of executable instructions cause:
presenting the images indicated by the indicators for display.

12. A system for displaying images on a display, said system comprising:
a decoder for decoding encoded images and parameters associated with the images, thereby resulting in decoded images and decoder parameters associated with the decoded images, wherein the decoder comprises a first processor;
image buffers for storing the decoded images; and
a display engine for presenting the images stored in the image buffers for display, wherein the display engine comprises a second processor.

13. The system of claim 12, further comprising:
parameter buffers for storing the decoded parameters associated with the images.

14. The system of claim 2, wherein the display engine presents the images by receiving the decoded parameters and displaying the decoded images based on the decoded parameters.
